(19) United States
(12) Patent Application Publication
(10) Pub. No.: US 2014/0003520 A1
(43) Pub. Date: Jan. 2, 2014

(54) Differentiating Decodable and Non-Decodable Pictures After RAP Pictures

(71) Applicant: Cisco Technology, Inc., San Jose, CA (US)

(72) Inventors: Arturo A. Rodriguez, Norcross, GA (US); Anil Kumar Katti, Atlanta, GA (US); Hsiang-Yeh Hwang, Duluth, GA (US)

(21) Appl. No.: 13/934,210

(22) Filed: Jul. 2, 2013

Related U.S. Application Data
(60) Provisional application No. 61/667,364, filed on Jul. 2, 2012.

(51) Int. Cl. H04N 7/32

(52) U.S. Cl. CPC H04N 19/00569
USPC 375/240.15

(57) ABSTRACT

In one embodiment, a non-decodable leading picture is identified. A picture is identified as a decodable picture when the picture follows a random access picture (RAP) in decode order and precede the same RAP in output order; and the picture is not inter-predicted from a picture that precedes the RAP in decode order. The identified decodable leading picture is coded with a respectively corresponding NAL unit type in a bitstream.

### TECHNICAL FIELD

The embodiments generally relate to video coding and more specifically, to processing of bitstreams of coded pictures provisioned with random access,

### BACKGROUND

In order to facilitate communication of video content over one or more networks, several coding standards have been developed. Video coding standards include ITU-T H.261, ISO/IEC MPEG-1 Video, ITU-T H.262 or ISO/IEC MPEG-2 Video, ITU-T H.263, ISO/IEC MPEG-4 Visual, ITU-T H.264 (also known as ISO/IEC MPEG-4 AVC). The latest video coding standard is the high-efficiency video coding (HEVC) standard.

Multi-level temporal scalability hierarchies enabled by video coding specifications are suggested to be used due to theft significant compression efficiency. However, theft coded pictures inter-dependencies may also cause problems when provisioning random access.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a conceptual diagram of relationship between VCL (Video Coding Layer) and NAL in a video coding specification such as the H.264/AVC standard.

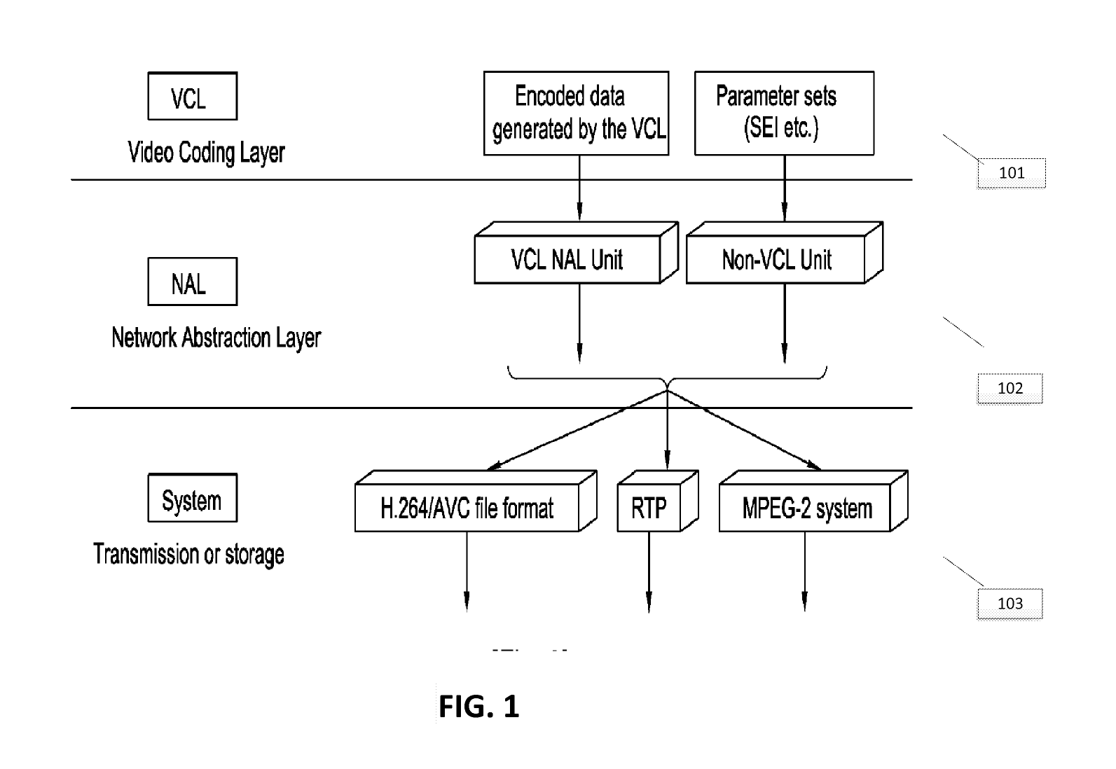

FIG. 2 is a flow chart illustrating embodiments of the present disclosure.

FIG. 3 is a flow chart illustrating embodiments of the present disclosure.

### DESCRIPTION OF EXAMPLE EMBODIMENTS

### Overview

In one embodiment, a decodable leading picture in a bitstream of coded pictures is identified after entering the bitstream at a random access point (RAP) picture. A picture is identified as a decodable leading picture when the picture follows the RAP picture in decode order and precedes the same RAP picture in output order; and the picture is not inter-predicted from a picture that precedes the RAP picture in decode order. The decodable leading picture is identified by a respectively corresponding NAL unit type.

### Example Embodiments

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

As noted above, the Advanced Video Coding (H.264/AVC) standard is known as ITU-T Recommendation H.264 and ISO/IEC international Standard 14496-10, also known as MPEG-4 Part 10 Advanced Video Coding (AVC). There have been several versions of the H.264./AVC standard, each integrating new features to the specification. The input to a video encoder is a sequence of pictures and the output of a video decoder is also a sequence of pictures. A picture may either be a frame or a field. A frame comprises one or more components such as a matrix of luma samples and corresponding chroma samples. A field is a set of alternate sample rows of a frame and may be used as encoder input, when the source signal is interlaced. Coding units may be one of several sizes of luma samples such as a 64×64, 32×32 or 16×16 block of luma samples and the corresponding blocks of chroma samples. A picture may be partitioned to one or more slices. A slice includes an integer number of coding tree units ordered consecutively in raster scan order. In one embodiment, each coded picture is coded as a single slice.

A video encoder outputs a bitstream of coded pictures corresponding to the input sequence of pictures. The bitstream of coded pictures is the input to a video decoder.

Each network abstraction layer (NAL) unit in the bitstream has a NAL unit header that includes a NAL unit type. Each coded picture in the bitstream corresponds to an access unit comprising one or more NAL units.

A start code identifies the start of a NAL unit header that includes the NAL unit type. A NAL unit can identify with its NAL unit type a respectively corresponding type of data, such as a sequence parameter set (SPS), a picture parameter set (PPS), an SEI (Supplemental Enhancement Information), or a slice which consists of a slice_header followed by slice data (i.e. coded picture data). A coded picture includes the NAL units that are required for the decoding of the picture.

NAL unit types that correspond to coded picture data identify one or more respective properties of the coded picture via their specific NAL unit type value. NAL units corresponding to coded picture data are provided by slice NAL units. Consequently, a leading picture can be identified as non-decodable or decodable by their respective NAL unit types.

When picture sequences are encoded to provision random access, such as for entering a bitstream of coded pictures corresponding to a television channel, some of the leading pictures after a RAP picture in decode order may be decodable because they are solely backward predicted from the RAP picture or other decodable pictures after the RAP. Some applications produce such backward predicted pictures when replacing an existing portion of the bitstream with new content to manage the constant-bit-rate (CBR) bitstream emissions while operating with reasonable buffer CPB delay. In another embodiment, some bitstreams are coded with hierarchical inter-prediction structures that are anchored by every pair of successive Intra pictures with a significant number of coded pictures between the Intra pictures. Backward predicted pictures after a RAP picture that are decodable are conveyed with an identification corresponding to a “decodable picture.”

A coded picture in a bitstream that follows a RAP picture in decoding order and precedes it in output order is referred to as a leading picture of that RAP picture. While it may be possible to associate leading pictures after a RAP picture as non-decodable when decoding is initiated at that RAP picture, there are applications that do benefit from knowing when the pictures after the RAP picture are decodable, although their output times are prior to the RAP picture's output time.

There are two types of leading pictures: decodable and non-decodable. Decodable leading pictures are such that they can be correctly decoded when the decoding is started from a RAP picture. In other words, decodable leading pictures use only the RAP picture or pictures after the RAP picture in decoding order as reference pictures in inter prediction. Non-decodable leading pictures are such that they cannot be correctly decoded when the decoding is started from the RAP picture. In other words, non-decodable leading pictures use pictures prior to the RAP picture in decoding order as reference picture for inter prediction.

Some applications produce backward predicted pictures when replacing existing coded video sequences with new content to manage the constant-bit-rate (CBR) bitstream emissions while operating with reasonable buffer CPB delay. Some bitstreams are coded with hierarchical inter-prediction structures that are anchored by every pair of successive Intra pictures in the bitstream with a significant number of coded pictures between them. Thus, in such embodiments, a significant number of non-decodable leading pictures may be identified. However, a splicer or DPI device may convert one or more of the non-decodable leading pictures to backward predicted pictures by using video processing methods.

Leading pictures are identified by one of two NAL unit types, either as a decodable leading picture or non-decodable leading picture. By doing so servers/network nodes could discard leading pictures as needed and when a decoder entered the bitstream at the RAP picture. Such leading pictures have been called TFD (“tagged for discard”) pictures. Some of these leading pictures could be backward predicted solely from the RAP picture or decodable pictures after the RAP in decode order.

In one embodiment, decodable leading pictures may be distinguished from the non-decodable leading pictures. As an example, backward predicted decodable pictures that are transmitted after a RAP picture and that have output time prior to the RAP picture may be distinguished from the non-decodable leading pictures associated with the given RAP picture that are not decodable because they truly depend on reference pictures that precede the RAP picture in decode order.

In one embodiment, the decodable leading picture, i.e. backward predicted pictures after a RAP picture which can be decoded, may not be marked as TFD (“tagged for discard”) pictures. A new definition for TFD pictures is proposed along with another type of NAL unit to identify leading pictures that are backward predicted and decodable from the associated RAP and/or other decodable pictures after the RAP. A TFD picture should be a picture that depends on a picture or information preceding the RAP picture, directly or indirectly.

Tagged for discard (TFD) picture: A coded picture for which each slice has nal_unit_type corresponding to an identification of non-decodable leading picture. When the decoding of a bitstream starts at a particular RAP, a picture that follows this RAP picture in decode order and precede the same RAP picture in output order is considered a TFD picture if it is either inter-predicted from a picture that precedes this RAP picture in both decode and output order or inter-predicted from another TFD picture. In such cases, a TFD picture is non-decodable.

Decodable with prior output (DWPO) access unit: An access unit in which the coded picture is a DWPO picture. Decodable with prior output (DWPO) picture: A coded picture for which each slice has nal_unit_type corresponding to an identification of decodable leading picture. When the decoding of a bitstream starts at a particular RAP, a picture that follows this RAP picture in decode order and precede the same RAP picture in output order is considered a DWPO picture if it is not a TFD picture. In such cases, a DWPO picture is fully decodable. The following table indicates change in nal_unit_type for the proposed changes.

TABLE 1
NAL unit type codes and NAL unit type classes

| | | NAL |
|---|---|---|
| | | unit |
| | Content of | type |
| nal_unit_type | NAL unit and RBSP syntax structure | class |
| 0 | Unspecified | non-VCL |
| 1 | Coded slice of a non-RAP, non-TFD and | VCL |
| | non-TLA picture | |
| | slice_layer_rbsp( ) | |
| 2 | Coded slice of a TFD picture | VCL |
| | slice_layer_rbsp( ) | |
| 3 | Coded slice of a non-TFD TLA picture | VCL |
| | slice_layer_rbsp( ) | |
| 4, 5 | Coded slice of a CRA picture | VCL |
| | slice_layer_rbsp( ) | |
| 6, 7 | Coded slice of a BLA picture | VCL |
| | slice_layer_rbsp( ) | |
| 8 | Coded slice of an IDR picture | VCL |
| | slice_layer_rbsp( ) | |
| 9 | Coded slice of an DWPO picture | VCL |
| | slice_layer_rbsp( ) | |
| 10 . . . 24 | Reserved | n/a |
| 25 | Video parameter set | non-VCL |
| | video_parameter_set_rbsp( ) | |
| 26 | Sequence parameter set | non-VCL |
| | seq_parameter_set_rbsp( ) | |
| 27 | Picture parameter set | non-VCL |
| | pic_parameter_set_rbsp( ) | |
| 28 | Adaptation parameter set | non-VCL |
| | aps_rbsp( ) | |
| 29 | Access unit delimiter | non-VCL |
| | access_unit_delimiter_rbsp( ) | |
| 30 | Filler data | non-VCL |
| | filler_data_rbsp( ) | |
| 31 | Supplemental enhancement information | non-VCL |
| | (SEI) sei_rbsp( ) | |
| 32 . . . 47 | Reserved | n/a |
| 48 . . . 63 | Unspecified | non-VCL |

For decoding a picture, an AU contains optional SPS, PPS, SEI NAL units followed by a mandatory picture header NAL unit and several slice_layer_rbsp NAL units.

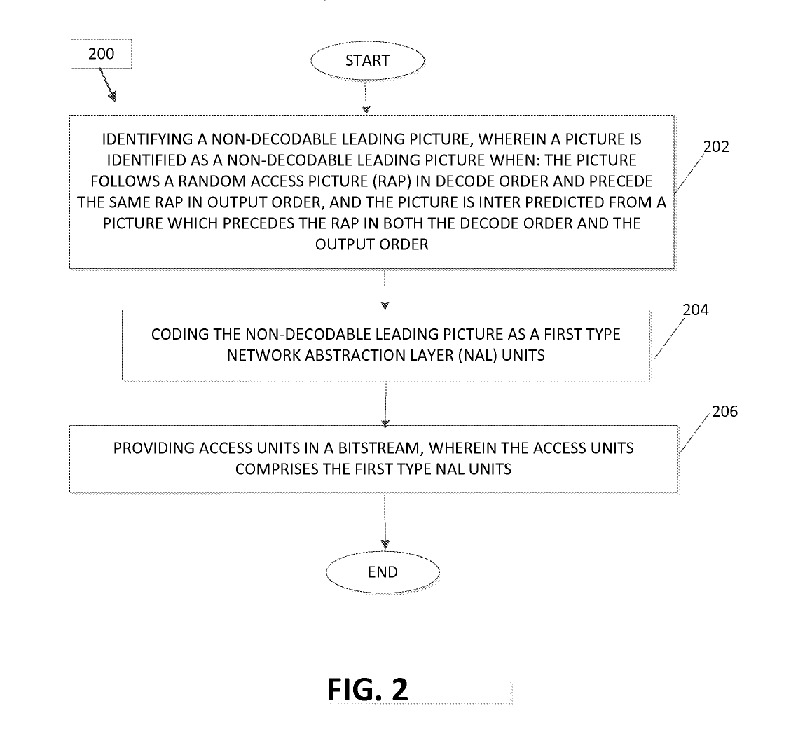

Referring to FIG. 2, shown is a simplified block diagram of an exemplary video system in which embodiments of the disclosure may be implemented. An encoder (101) can produce a bitstream (102) including coded pictures with a pattern that allows, for example, for temporal scalability. Bitstream (102) is depicted as a bold line to indicate that it has a certain bitrate. The bitstream (102) can be forwarded over a network link to a media aware network element (MANE) (103). The MANE'S (103) function can be to “prune” the bitstream down to a certain bitrate provided by second network link, for example by selectively removing those pictures that have the least impact on user-perceived visual quality. This is shown by the hairline line for the bitstream (104) sent from the MANE (103) to a decoder (105). The decoder (105) can receive the pruned bitstream (104) from the MANE (103), and decode and render it.

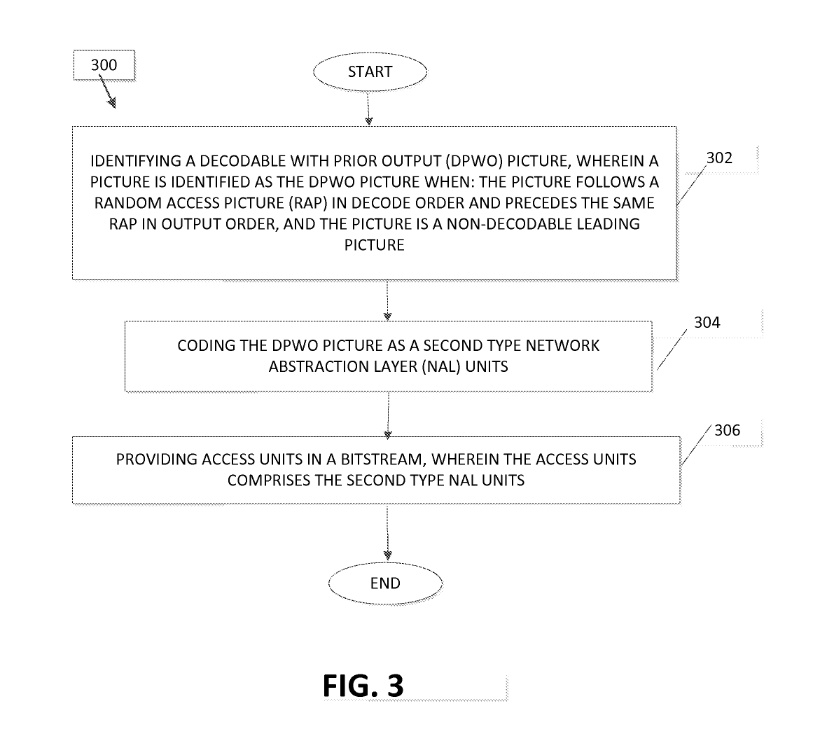

FIG. 3 shows conceptual structure of video coding layer (VCL) and network abstraction layer (NAL). As shown in FIG. 3, a video coding specification such as H.264/AVC is composed of the VCL (201) which encodes moving pictures and the NAL (202) which connects the VCL to lower system (203) to transmit and store the encoded information. Independently of the bit stream generated by the VCL (201), there are sequence parameter set (SPS), picture parameter set (PPS), and supplemental enhancement information (SEI) for timing information for each picture, information for random access, and so on.

Having described various embodiments of the video encoding, it should be appreciated that one encoding method embodiment 300, implemented at an encoder 101 and illustrated in FIG. 2, can be broadly described as identifying a non-decodable leading picture, wherein a picture is identified as the non-decodable leading picture when: the picture follows a random access picture (RAP) in decode order and precede the same RAP in output order, and the picture is inter-predicted from a picture which precedes the RAP in both the decode order and the output order (302); coding the non-decodable leading picture as a first type network abstraction layer (NAL) units (304); and providing access units in a bitstream, wherein the access units comprises the first type NAL units (306).

Another encoding method embodiment 400, implemented at an encoder 101 and illustrated in FIG. 2, can be broadly described as identifying a decodable with prior output (DPWO) picture, wherein a picture is identified as the DPWO picture when: the picture follows a random access picture (RAP) in decode order and precede the same RAP in output order, and the picture is not a non-decodable leading picture (402); coding the DPWO picture as a second type of network abstraction layer (NAL) units (404); and providing a DPWO access unit in a bitstream, wherein the DPWO access unit comprises the second type of NAL units (406).

Any process descriptions or blocks in flow charts or flow diagrams should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved, as would be understood by those reasonably skilled in the art. In some embodiments, steps of a process identified in FIG. 3 using separate boxes can be combined. Further, the various steps in the flow diagrams illustrated in conjunction with the present disclosure are not limited to the architectures described above in association with the description for the flow diagram (as implemented in or by a particular module or logic) nor are the steps limited to the example embodiments described in the specification and associated with the figures of the present disclosure. In some embodiments, one or more steps may be added to the method described in FIG. 3, either in the beginning, end, and/or as intervening steps, and that in some embodiments, fewer steps may be implemented.

It should be emphasized that the above-described embodiments of the present disclosure are merely possible examples of implementations, merely set forth for a clear understanding of the principles of the video coding and decoding systems and methods. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

What is claimed is:

1. A method of video encoding, the method comprising:
identifying a non-decodable leading picture, wherein a picture is identified as the non-decodable leading picture when:
the picture follows a random access picture (RAP) in decode order and precede the same RAP in output order, and
the picture is inter-predicted from a picture which precedes the RAP in both the decode order and the output order;
coding the non-decodable leading picture as a first type network abstraction layer (NAL) units; and
providing access units in a bitstream, wherein the access units comprises the first type NAL units.

2. The method of claim 1, wherein coding the non-decodable leading picture as the first type NAL units comprises coding the non-decodable leading picture as the first type NAL units wherein the first type NAL units comprises a start code and a nal_unit_type_field.

3. The method of claim 2, wherein coding the non-decodable leading picture as the first type NAL units having the start code and the nal_unit_type_field comprises coding the non-decodable leading picture as the first type NAL units having the the nal_unit_type_field.

4. The method of claim 1, further comprising tagging the non-decodable leading picture as tag for discard (TFG) picture.

5. The method of claim 4, wherein tagging the non-decodable leading picture as the TFG picture further comprising tagging the non-decodable leading picture as the TFG picture, wherein the TFG picture is discarded during a random access operation.

6. The method of claim 4, wherein tagging the non-decodable leading picture as the TFG picture further comprising tagging the non-decodable leading picture as the TFG picture.

7. The method of claim 4, wherein tagging the non-decodable leading picture as the TFG picture further comprising tagging the non-decodable leading picture as the TFG picture, wherein the TFG picture is discarded when a bit rate of the bitstream is to reduced.

8. The method of claim 1, further comprising:
identifying decodable with prior output (DPWO) picture, wherein a picture is identified as the DPWO picture when:
the picture follows the RAP in decode order and precede the same RAP in output order, and
the picture is not the non-decodable leading picture;
coding the DPWO picture as a second type of network abstraction layer (NAL) units; and
providing a DPWO access unit in the bitstream, wherein the DPWO access unit comprises the second type of NAL units.

9. The method of claim 8, wherein coding the DPWO picture as the second type NAL units comprises coding the DPWO picture as the second type NAL units wherein the second type NAL units comprises a start code and a nal_unit_type_field.

10. The method of claim 9, wherein coding the DPWO picture as the second type of NAL units having the start code and the nal_unit_type_field comprises coding the DPWO picture as the second type of NAL units having the nal_unit_type_field.

11. A method of video encoding, the method comprising:
identifying a decodable with prior output (DPWO) picture, wherein a picture is identified as the DPWO picture when:
the picture follows a random access picture (RAP) in decode order and precede the same RAP in output order, wherein the picture is not a non-decodable leading picture;
coding the DPWO picture as a second type of network abstraction layer (NAL) units; and
providing a DPWO access unit in a bitstream, wherein the DPWO access unit comprises the second type of NAL units.

12. The method of claim 11, wherein coding the DPWO picture as the second type NAL units comprises coding the DPWO picture as the second type NAL units wherein the second type NAL units comprises a start code and a nal_unit_type_field.

13. The method of claim 12, wherein coding the DPWO picture as the second type of NAL units having the start code and the nal_unit_type_field comprises coding the DPWO picture as the second type of NAL units having the nal_unit_type_field.

14. The method of claim 11, wherein identifying the picture is not the non-decodable leading picture comprises identifying the picture is not the non-decodable leading picture, when
the picture follows the RAP in the decode order and precede the same RAP in the output order, and
the picture is inter-predicted from a picture that precedes the RAP in both the decode order and the output order.

15. The method of claim 14, further comprising:
coding the non-decodable leading picture as a first type network abstraction layer (NAL) units; and
providing the access units in a bitstream, wherein the access units comprises the first type NAL units.

16. The method of claim 15, wherein coding the non-decodable leading picture as the first type NAL units comprises coding the non-decodable leading picture as the first type NAL units wherein the first type NAL units comprises a start code and a nal_unit_type_field.

17. The method of claim 16, wherein coding the non-decodable leading picture as the first type NAL units having the start code and the nal_unit_type_field comprises coding the non-decodable leading picture as the first type NAL units having the the nal_unit_type_field.

18. The method of claim 11, wherein identifying the picture that follows the RAP comprises identifying the picture that follows the RAP wherein the RAP is an intra-coded picture.

19. The method of claim 11, wherein identifying the DPWO picture comprises identifying the DPWO picture wherein the DPWO picture is an inter-coded picture.

20. A video encoder comprising a processor configured with logic to perform the steps of:
identifying a non-decodable leading picture, wherein a picture is identified as a non-decodable picture when:
the picture follows a random access picture (RAP) in decode order and precede the same RAP in output order, and
the picture is inter-predicted from a picture which that precedes the RAP in both the decode order and the output order; and
coding the non-decodable leading picture as a first type network abstraction layer (NAL) units;
identifying a decodable with prior output (DPWO) picture, wherein a picture is identified as the DPWO picture when:
the picture follows the RAP in the decode order and precede the same RAP in the output order, and
the picture is not the non-decodable leading picture;
coding the DPWO picture as a second type of network abstraction layer (NAL) units; and
providing access units in a bitstream, wherein the access units comprises the first type NAL units and the first type NAL units.
